(19) United States
(12) Patent Application Publication
(10) Pub. No.: US 2004/0244868 A1
(43) Pub. Date: Dec. 9, 2004

(54) Forest machine

(76) Inventor: Risto Heikkila, Oulainen (FI)

Correspondence Address: YOUNG & THOMPSON, 745 SOUTH 23RD STREET, 2ND FLOOR, ARLINGTON, VA, 22202, US

(21) Appl. No.: 10/487,347

(22) PCT Filed: Feb. 13, 2003
(86) PCT No.: PCT/FI03/00113

(30) Foreign Application Priority Data
Feb. 15, 2002 (FI) 20020310

(51) Int. Cl. A01G 23/08

(52) U.S. Cl. 144/4.1; 144/34.1

(57) ABSTRACT

The invention relates to a forest machine camprising a base (1) and a cabin (7), power source (8), loader (9) as well as a loading space (23) arranged thereto. The loading space is preferably arranged to form at the front end of the base a part connected with an articulated joint. In order to diversify the use of the forest machine, the cabin (7), loader (9) and power source (8) of the machine are arranged to be movable in relation to the base (1). Thus, depending on the location of the cabin, loader and the power source, the loading space in the machine is at least partly covered or released completely. A forest machine is thus provided that according to need is able to select between the most appropriate location of the centre of gravity and the use of the loading space (23).

### FIELD OF THE INVENTION

The present invention relates to a forest machine according to the preamble of claim 1.

Such a forest machine is intended for carrying out both main stages of logging, meaning felling and forest haulage.

### BACKGROUND OF THE INVENTION

In present mechanized logging, the work is typically carried out using two separate machines, particularly in final felling. The trees are thus felled during the initial stage of felling by means of what is known as a single grip harvester, whereupon the logs cut from the felled and delimbed trees are transported from the felling site next to the road path with a separate forwarder. In cases, where a combined machine constructed into a single common frame is used for both felling and forest haulage, such a machine is particularly intended for thinning small-scale forests owing to the light-weight structure thereof. However, such current light weight and small combined machines are not particularly well suited to be used in heavy final felling or haulage of heavy loads owing to the small dimensions and haulage power thereof.

When a full-grown tree is felled during final felling, the tree to be processed is conventionally large and heavy, whereby the centre of gravity of the tree is generally during processing placed considerably far from the base machine. In order to be able to process such a tree in general, large and powerful machines must be used. Felling therefore requires both a heavy and strong base machine in order to be able to compensate for the heavy load caused by the inappropriate location of the centre of gravity of the tree to be felled. An adequately heavy base machine is achieved by combining the part including a cargo space with the single grip harvester as is known in the art, but at the same time the agility of the single grip harvester in felling is lost. As the machine becomes more difficult to manage and as the haulage capacity decreases, the working time used for each felling area increases, thus significantly reducing the productivity of the work.

### BRIEF DESCRIPTION OF THE INVENTION

It is an object of the present invention to avoid the drawbacks associated with prior art solutions and to achieve a new kind of forest machine. Such a flexible and multifunctional forest machine according to the invention may significantly improve the technique associated with current forestry and forest felling.

This object is achieved so that the forest machine is provided with the characteristics defined in the claims according to the invention. More precisely, the apparatus according to the invention is mainly characterized in what is disclosed in the characterizing part of claim 1.

The invention is based on the fact that even if the present forest machine operates as a multifunctional machine, it is nevertheless heavy enough to be able to function completely individually even during final felling. Thus, the forest machine can be used to perform both felling and haulage of felled timber. The forest machine according to the invention can be used to carry out all the work previously performed using two machines.

In a preferred embodiment a forest machine cabin, loader and a power source of the forest machine are arranged to move in relation to the base provided in the forest machine by means of parallel motion, thus being movable into different parts of the longitudinal axis of the base as required.

The other preferred embodiments of the invention are disclosed in the dependent claims.

In addition to those mentioned above, the invention provides other significant advantages too. Thus, the present forest machine, or what is known as a combined machine, always provides the required stability in the most varying working conditions. Since such a forest machine is constantly working at an optimal location of the centre of gravity, it also forms an adequatley stable base machine for the loader provided with an adequate range to be arranged thereto. The loader provided with an adequate range, in turn, ensures a distinctly better efficiency concerning felling compared to the current combined machines.

As the loader is arranged onto the same preferably rotatable base, or what is known as an upper plate, as the forest machine cabin or power source, they form a significant counterweight to the loader during operation. Such a structure allows processing tree trunks larger than usually, thus substantially improving the power of the present forest machine compared with prior art solutions.

The mobility of the cabin in the forest machine according to the invention provides a particularly significant advantage. As the cabin may be moved in the horizontal direction in relation to the frame of the base, the driver of the forest machine is always provided with a particularly good visibility both to the felling object and to the vehicle path. Moving the cabin also allows shifting the centre of gravity of the forest machine while working and while driving. Therefore, for instance when driving in a hilly terrain, a particularly heavy weight may be placed upon the front axis of the machine.

What has previously proven to be particularly difficult for a machine of the present frame steering type is to maintain the balance when the front and rear frames are turned in relation to a steering joint. However, moving the cabin, power source and loader in relation to the base machine frame provides a compensating power effect for the inappropriate location of the centre of gravity. The present forest machine is therefore distinctly more stable than previous combined machines, and can be utilized in more difficult terrains than before.

Then again, a working machine is provided in accordance with the method of the invention by connecting together the front and rear frames of the forest machine with a slewing ring, the working machine having a considerably stiff and stable frame. The slewing ring simultaneously allows obtaining a working machine, which is provided with a frame structure that is simple and lower and whose ground clearance is particularly good.

Since only one machine is required for carrying out felling with the forest machine according to the invention, the wear concerning growing stock and wood soil is naturally significantly reduced. Felling carried out using such a forest machine according to the invention is thus much more environmentally friendly than before.

Many studies show that the work becomes more meaningful when forest felling is carried out using a combined machine resembling the present forest machine. As the same driver is able to carry out both working stages of logging, i.e. felling and forest haulage, using the same machine the work becomes more varied. This in turn improves the meaning and motivation of the work and increases the productivity of the work.

Since only a single forest machine according to the invention needs to be purchased for carrying out felling, the costs of felling are kept at a significantly lower level than normally without reducing the efficiency of the work.

Manufacturing the present forest machine is also technically easier, as the same structure always allows obtaining a similar machine from the same production line for harvesting and haulage. Thus, the manufacturer achieves considerable savings as the various machine types are reduced. Significant savings are also achieved during the manufacturing process, since no investments are required for a second production line or for manufacturing chambers thereof. The second hand sales of such a combined machine is also considerably easier than that of previous forest machines, since the number of required replacement parts is smaller.

### BRIEF DESCRIPTION OF THE DRAWINGS

In the following the invention will be described by means of the accompanying drawings, in which

FIG. 1 shows a forest machine according to a preferred embodiment of the invention in the driving and felling positions,

FIG. 2 illustrates the forest machine shown in FIG. 1 in the hauling position,

FIG. 3 illustrates the forest machine shown in FIG. 1 in cross section from point A to A,

FIG. 4 illustrates an alternative embodiment of the forest machine shown in FIG. 1 in cross section from point A to A,

FIG. 5 illustrates partially in longitudinal section the forest machine shown in FIG. 1, including frame pivoting,

FIG. 6 is a top view illustrating the frame pivoting shown in FIG. 5 from point B to B,

FIG. 7 illustrates partially in cross section an upper plate with swivel bearings receiving a cabin and a loader of the forest machine according to FIG. 5 from point C to C,

FIG. 8 illustrates partially in cross section the connection of a power source and a supporting base thereof of the forest machine according to FIG. 5 from point D to D,

FIG. 9 shows an articulated joint between the movable parts of the forest machine, the parts being placed on the base in the position according to FIG. 1,

FIG. 10 shows the articulated joint according to FIG. 1, when the forest machine is directed to turn,

FIG. 11 shows the articulated joint between the movable parts of the forest machine, the parts being placed on the base in the position according to FIG. 2,

FIG. 12 shows the articulated joint according to FIG. 2, when the forest machine is directed to turn,

FIG. 13 shows partially in longitudinal section the forest machine, in which the loader and the cabin are arranged onto the same upper plate, and

FIG. 14 shows partially in longitudinal section the forest machine, in which the loader and the power source are arranged onto the same upper plate.

### DETAILED DESCRIPTION OF THE PREFERRED EMBODIMENTS

Some of the preferred embodiments of the present forest machine are described in the following with reference to the Figures mentioned above. The forest machine then comprises the structural parts indicated with reference numerals that correspond to the reference numerals used in this specification.

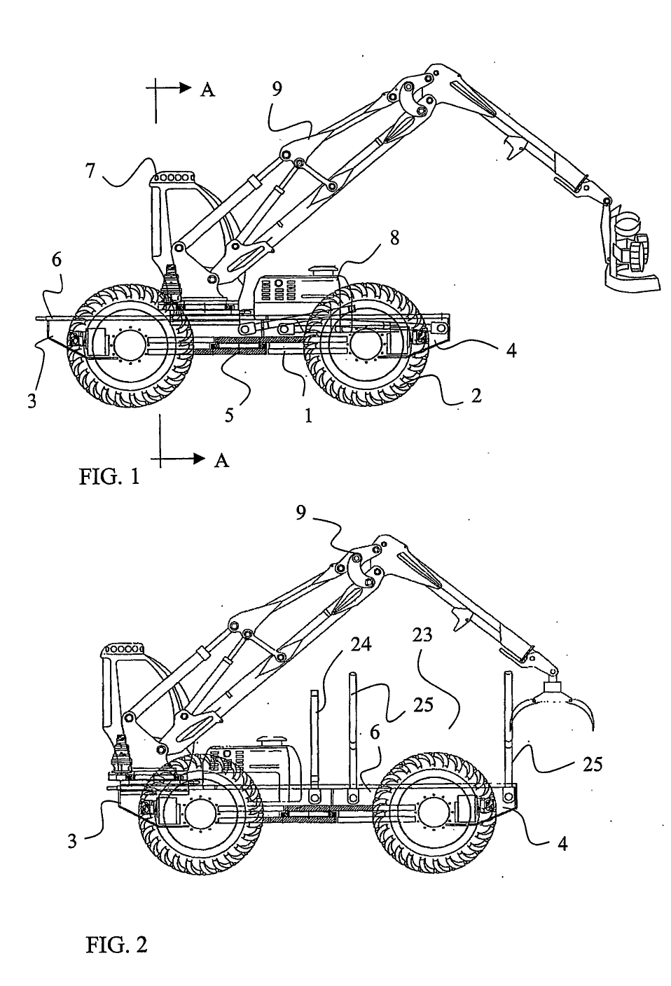

The first embodiment of the present forest machine shown in FIGS. 1 and 2 comprises a base 1 including power transmission and driving elements such as wheels 2. The base comprises a two-part frame steered structure formed of a front frame 3 and a rear frame 4. In the embodiment of the present forest machine the pivoting between the frame parts is arranged to be carried out using stewing rings 5. Such a slewing ring allows obtaining a base structure that is particularly low and simultaneously torsionally stiff in relation to the longitudinal axis of the forest machine.

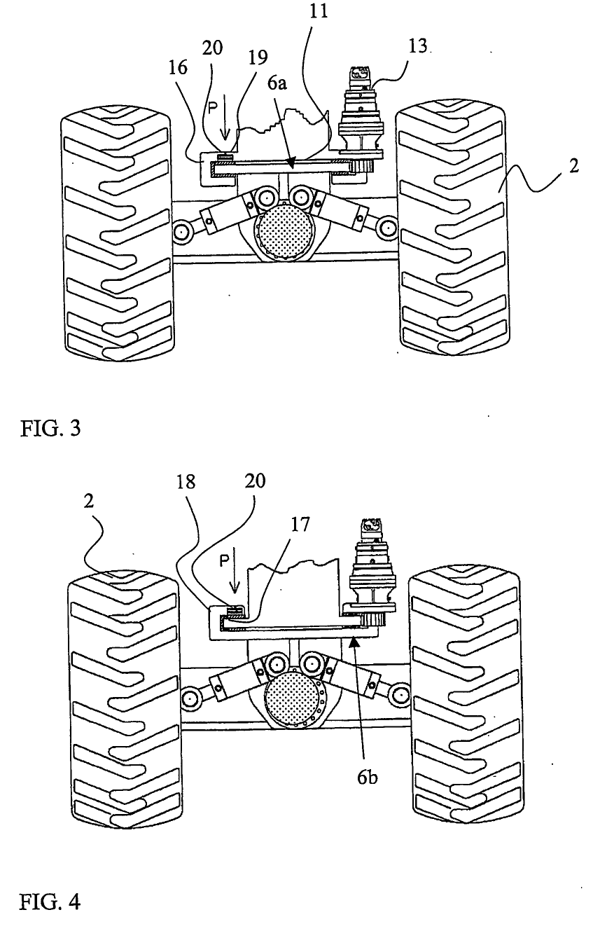

Thus, the front frame 3 and the rear frame 4 comprise plate-like base structures according to the Figures that provide the forest machine with a large ground clearance. A separate sub-frame 6 consisting of two parts and divided like the base 1 into a front and a rear part is preferably arranged onto the base plates formed by the base structure. The sub-frame then comprises prises for instance an element 6a substantially parallel with the plate-like front and rear frames according to FIG. 3. The sub-frame is then connected to the base using a joint structure known per se in such a manner that the outer edges in the direction of the longitudinal axis of the forest machine form projection flanges regarding the joint structure.

A second preferred embodiment of the sub-frame comprises an element 6b substantially parallel with the front and rear frames 3 and 4 according to FIG. 4. The sub-frame is then connected to the base using a joint structure known per se. Opposite forked means opening towards one another are formed at the outer edges of the sub-frame in the direction of the longitudinal axis of the forest machine.

The present forest machine is characterized in that a cabin 7 therein and preferably also a power source 8, i.e. an engine unit, in the forest machine are arranged to be movable in relation to the base 1 by means of the sub-frame. As the forest machine is provided with a loader 9, the loader is preferably arranged close to the cabin, for instance through a loader mounting 10 receiving the loader. Thus, the loader at the cabin is also movable in relation to the base. In order to move the cabin, loader and power source, said parts are mounted on upper plates 11 and 12 connected together. The upper plates are arranged to slide in relation to the parallel element 6aor the forked elements 6b. Such parallel motion is arranged to be achieved using mechanical or electro-mechanical means 13, such as a cogwheel-gear rack combination, in other words by means of what is known as a gear assembly or pressure medium actuators 14, such as pressure air or hydraulic cylinders.

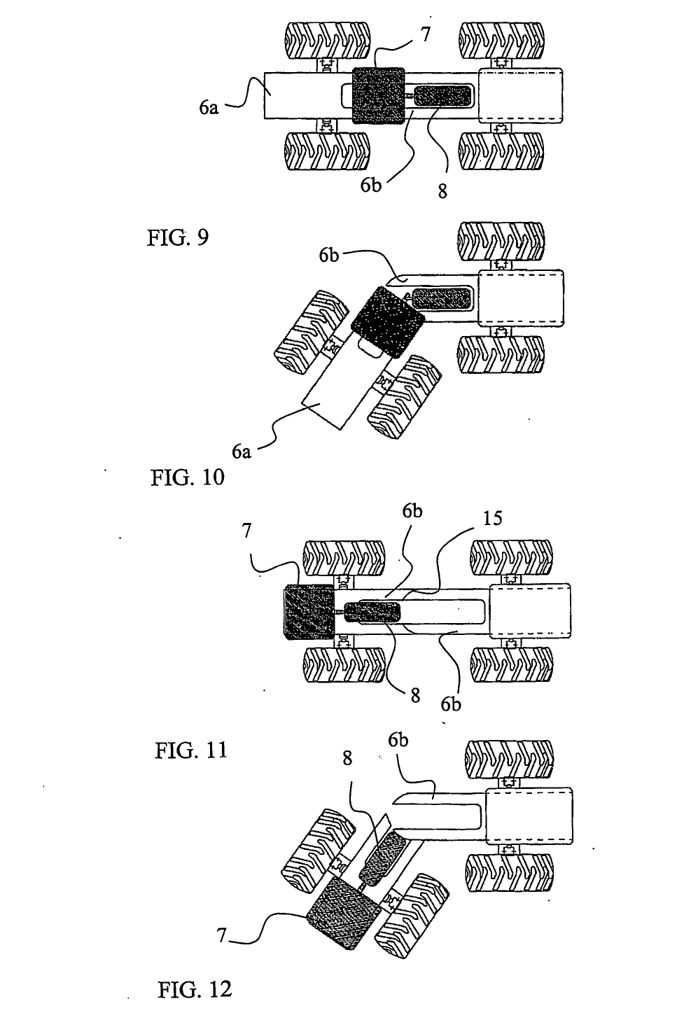

In order to move the cabin 7, loader 9 and power source 8 along the base 1 of the forest machine, the sub-frame 6 is extended from the front part of the front frame to the rear part of the rear frame in accordance with FIGS. 9 to 12, while the sub-frame is arranged to form uniform control means when the forest machine is in a straight driving position in accordance with FIGS. 9 or 11. The sub-frame is further provided at the joint between the front and rear frames with a round curved boundary surface 15 allowing the frame parts of the forest machine to turn in relation to one another.

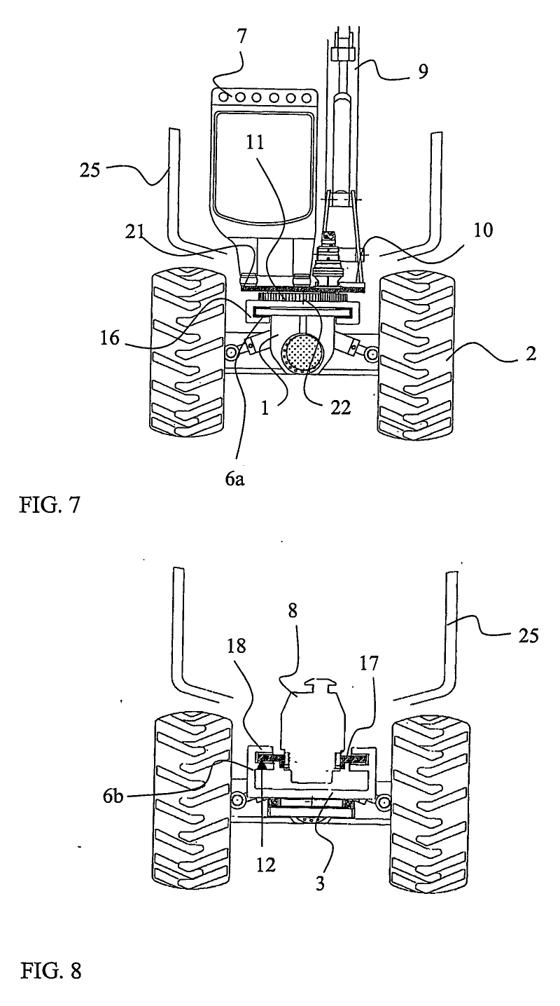

The sub-frame 6 enabling to move the cabin 7, loader 9 and power source 8 together with the upper plates 11 and 12 provide the forest machine in a manner known per se with a slide guide, parallel to the longitudinal axis of the forest machine and slidably lodged to one another. Thus, FIGS. 3 and 7 show a first preferred embodiment of such a slide guide, in which the sub-frame 6a comprises plate-like means substantially in the horizontal direction, on which said cabin, loader and power source are to be arranged, for instance by means of support means. In such a solution, the slide guide is achieved by extending gripping means 16 on the upper plates 11 and 12 to partly surround the parallel flange-like outer edges of sub-frame 6a forming the receiving means. Consequently, a control element that is torsionally stiff in respect of the longitudinal axis of the base is formed.

In the embodiment according to FIGS. 4 and 8, the slide guide formed by sub-frame 6b and the upper plates 11 and 12 comprises substantially horizontal flanges 17 in the upper plates 11 and 12. These flanges are arranged to extend to the preferably fork-shaped means 18 in the sub-flame for partly surrounding the flanges. Thus, a control element that is torsionally stiff in respect of the longitudinal axis of the forest machine base is achieved.

In order to lock the movable parts of the forest machine formed by the cabin 7, loader 9 and power source 8 in respect of the base into a stiff position, the above described slide guide also comprises braking means 19 for preventing the motion of the cabin, loader or power source taking place in respect of the sub-frame. A preferred embodiment of such braking means comprises in accordance with FIGS. 3 or 4 a compressing part 20, which is arranged to be compressed using a cylinder integrated by pressure, for instance against the outer edge, flange 17 or forked element 18 on the upper plate 11 or 12. Owing to the compressive force, the clearance between the upper plate and the sub-frame is locally removed, thus preventing the motion of the slide guide in the longitudinal direction.

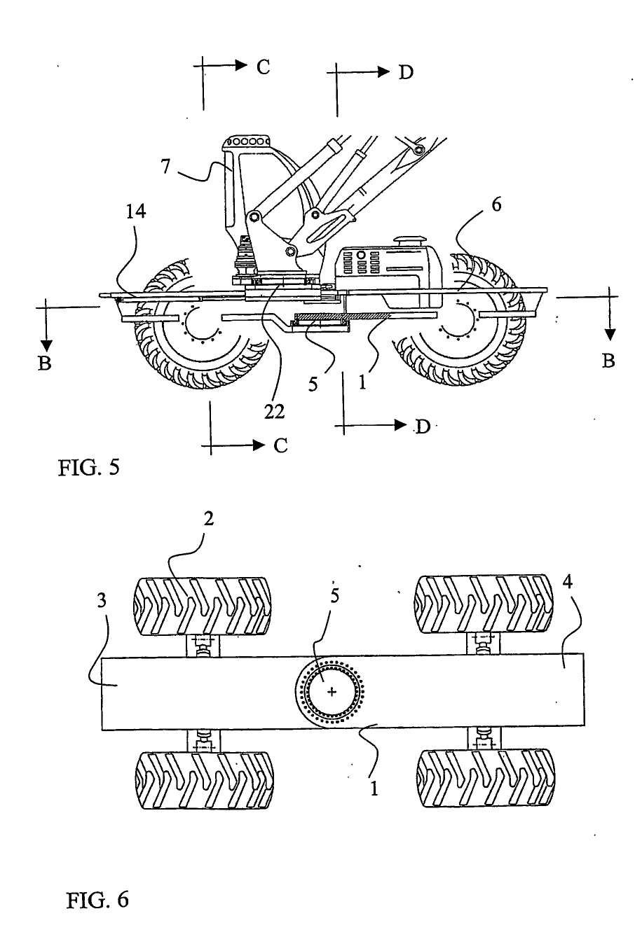

As is understood from the above, the movable parts are arranged onto several upper plates 11 and 12 moving in relation to the sub-frame 6. Therefore, in accordance with the present embodiment, the cabin 7 and the power source 8 are arranged onto specific upper plates thereof, which are preferably mechanically pivoted to each other in accordance with the accompanying FIGS. 5 and 9 to 12. While the cabin and the power source are articulated in respect of one another, the frame parts 3 and 4 being connected to the joint 5 of the forest machine may still be directed in relation to one another into a foldable position, even though the movable parts were to be placed on different frame parts when control is carried out. This is specifically demonstrated in the appended FIGS. 10 and 12.

The movable parts of the forest machine forming the cabin 7, loader 9 and power source 8 or the upper plates receiving said parts are preferably attached to one another by a mechanical joint known per se. Such a joint is, for instance, a sleeve-pin joint, a chain joint or a cable joint.

Naturally folding the frame parts 3 and 4 in relation to one another may also be carried out in an embodiment, in which the cabin 7, loader 9 and power source 8 or the upper plates 11 and 12 receiving said parts are movable irrespective of one another in relation to the base 1 of the forest machine. Then, the cabin, loader or power source can be placed, if necessary, at the opposite ends of the base when the use of the forest machine so requires.

To move the cabin, loader, power source or the upper plates receiving said parts in respect of the base could be carried out, for instance, using single-acting or double-acting actuators. Thus, both outermost movable parts of the forest machine or the upper plate are arranged to communicate with an actuator, one end of which being attached to the base. When the actuator is single acting, it pushes the part of the forest machine attached thereto and simultaneously forces other parts of the forest machine to slide in front thereof by means of the pushing surfaces placed between the parts.

A situation can be considered, in which the cabin, loader and power source are arranged onto the upper plates 11 and 12. When the upper plates are located in accordance with FIG. 1 on both sides of the slewing ring 5, the actuator in the rear frame 4 provides the upper plate 12 with a power effect. The power effect directs the upper plate 12 to the front frame 3, at the same time pushing the upper plate 11 in front thereof into the position shown in FIG. 2. When the upper plate 11 in turn is provided with a power effect using the actuator in the front frame, the upper plate 12 is directed to the rear frame into the position shown in FIG. 1, since the upper plate 11 pushes the upper plate 12 in front thereof.

The appended FIGS. 5 and 8 show in more detail the preferred location of the power source 8 on the upper plate 12. Thus, the oil sump of the power source may preferably extend beneath the upper plate and thus provide the structure with a preferable centre of gravity. Such particular placing of the power source to a position penetrating the upper plate 12 requires, however, to form the sub-frame 6 so as to include forked means 6b or a combination tion of parallel means 6a and forked means 6b.

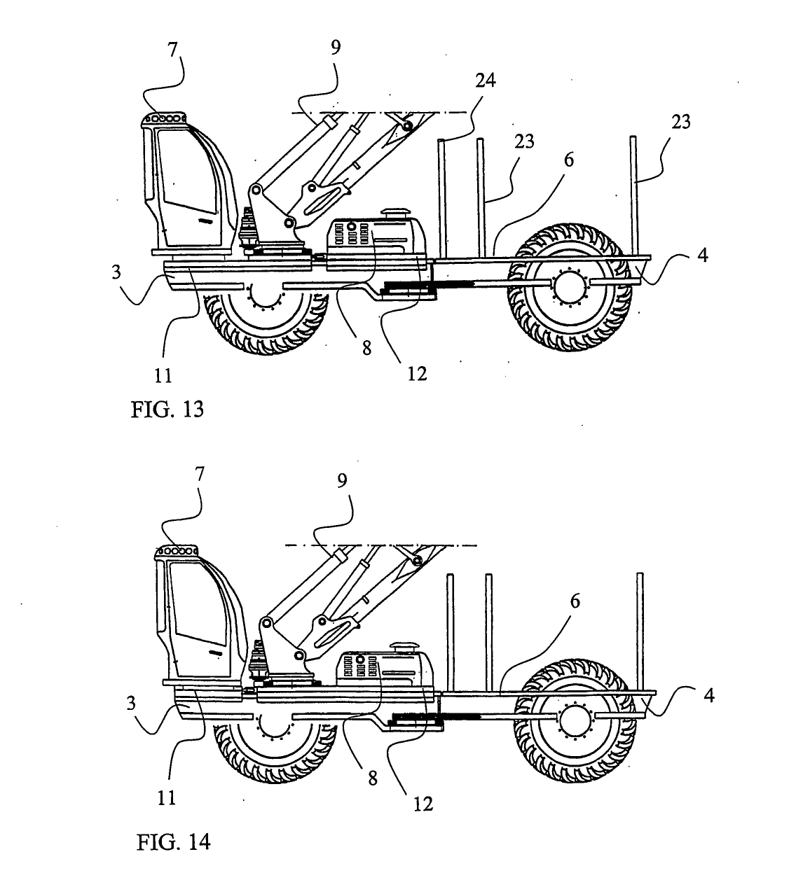

In the above-described embodiment, a loader 9 may also be arranged onto the same upper plate 11 with the cabin 7. This embodiment is also shown in FIG. 13, in which the loader is placed between the cabin and the power source 8. FIG. 14, in turn, shows an embodiment, in which the loader is placed between the cabin and the power source in such a manner that the loader is arranged onto the same upper plate 12 as the power source. In such an embodiment, the loader is preferably attached to the upper plate through the loader mounting 10. It is also possible to arrange the upper plate or at least the parts of the forest machine arranged thereto to be rotatably placed in respect of the base 1 in order to increase the range of the loader or in order to achieve the necessary counterbalance during loading and unloading.

At least the cabin 7 to be arranged onto the upper plate 11 is rotatably placed in accordance with a particular embodiment in respect of the axis that is perpendicular in relation to the upper surface formed on the base 1. Thus, the cabin is for instance arranged onto the upper plate by means of a sub-plate 21 and a particular swivel bearing 22 joining the upper plate. In an embodiment, where the same sub-plate comprises both a loader and a power source, these parts are preferably arranged on the opposite sides of the sub-plate. Consequently, the power source forms a counterbalance to the loader and to the tree trunk to be processed therein. The use of such a power source as a counterbalance allows processing substantially larger tree trunks in the forest machine when comparing the forest machine with working machines of similar type and size.

The present forest machine provides as a particular advantage, for instance in the position according to FIG. 1, at each moment of time a most balanced working position, thus providing good stability. Then again, the parts to be moved in respect of the longitudinal axis of the forest machine provide another significant advantage. When moving the cabin 7, loader 9 and the engine unit 8 in the longitudinal direction of the basel into the other extreme end of the forest machine, a loading space 23 conventionally in the rear frame of the forest machine is released. Consequently, a front wall 24 and loading supports 25 in the loading space pivoted onto the base can be folded in a manner known per se mechanically by hand or using pressure medium actuators into an upright position for receiving tree trunks and for hauling them to the loading area.

The forest machine according to the present embodiments has a superior range of operation in relation to a conventional harvester, whereby the productivity of the machine from one felling area increases. In addition, such a machine may be used to perform different working stages using the same base machine, in which case the equipment investments decrease considerably from the current. Working with such a machine is also more meaningful for the driver of the machine as he is able to work with both felling and hauling. Since the cabin 7 and loader 9 of the forest machine can be arranged to the common swivel bearing 22 connecting to the base, said parts can be turned in respect of the base about the vertical axis of the forest machine. Thus, the visibility of the driver can be improved as well as the range of the loader.

It is to be understood that the above specification and the Figures associated therewith are only intended to illustrate the present invention. The invention is therefore not merely restricted to the above or to the embodiment defined in the claims, but it will be obvious for those skilled in the art that the invention can be varied and modified in various ways within the scope of the inventive idea defined in the appended claims.

1-17. (cancelled)

18. A forest machine comprising preferably a two-piece base formed of a front frame and a rear frame jointed together, the base being provided with
a power source including moving elements moving the forest machine in relation to the ground thereof,
a cabin provided for the driver of the forest machine,
a power source for employing the machines and devices in the forest machine, and
a loader and a loading space, while the loading space is arranged into the rear frame of the forest machine,
whereby the cabin together with the loader and the power source are arranged to be movable in respect of the base at least partly along the length thereof from a position at least a partly covering the loading space to a position substantially releasing the loading space, so that
the moving motions of the movable parts in the forest machine formed of the cabin, loader and power source are arranged to depend upon one another, whereby
the cabin, loader and power source are arranged to be moved in relation to the base (1) using parallel motion.

19. A forest machine as claimed in claim 18 wherein the loader is arranged between the cabin and the power source.

20. A forest machine as claimed in claim 18, wherein the cabin and the loader are arranged onto a common construction base, or an upper plate.

21. A forest machine as claimed in claim 18, wherein the power source and the loader are arranged onto a common construction base, or an upper plate.

22. A forest machine as claimed in claim 21, wherein the cabin, loader and power source to be moved in relation to the base of the forest machine are arranged onto the base by means of a slide guide, which comprises on the base of the forest machine substantially longitudinal receiving means, and gripping means are arranged to extend from the movable parts or from the parts receiving said parts close to the receiving means and partly to surround them in order to provide a torsionally stiff joint between the movable parts and the base.

23. A forest machine as claimed in claim 22 wherein the slide guide comprises braking means for preventing the motion between the sub-frame, comprising the substantially longitudinal receiving means, and the cabin, loader or power source.

24. A forest machine as claimed in claim 23, wherein the braking means (19) comprise a compressing part arranged to be compressed using a pressurized integrated cylinder against the sub-frame or the upper plate.

25. A forest machine as claimed in claim 21, wherein the cabin, loader and power source to be moved in relation to the base of the forest machine are arranged onto the base by means of a slide guide, which comprises flanges extending towards the base from the movable parts of the forest machine or from the parts receiving said parts and substantially longitudinal receiving means on the base comprising gripping means partly surrounding the flanges in order to provide a torsionally stiff joint between the movable parts and the base.

26. A forest machine as claimed in claim 25, wherein the slide guide comprises braking means for preventing the motion between the sub-frame, comprising the substantially longitudinal receiving means, and the cabin, loader or power source.

27. A forest machine as claimed in claim 26, wherein the braking means comprise a compressing part arranged to be compressed using a pressurized integrated cylinder against the sub-frame or the upper plate.

28. A forest machine as claimed in claim 18, wherein actuators placed on the base are arranged to move the movable parts of the forest machine in the longitudinal direction of the base.

29. A forest machine as claimed in claim 28, wherein the actuators are operable by means of pressure medium.

30. A forest machine as claimed in claim 28, wherein the actuators comprise a gear assembly.

31. A forest machine as claimed in claim 20, wherein the cabin and the loader are arranged on a common swivel bearing in order to achieve a rotational motion about the vertical axis.

32. A forest machine as claimed in claim 21, wherein the power source and loader are arranged on a common swivel bearing in order to achieve a rotational motion about the vertical axis.

33. A forest machine as claimed in claim 21, wherein on the other hand the cabin, loader and power source or the upper plates receiving said parts are mechanically articulated to one another.

34. A forest machine as claimed in claim 18, wherein the loading space is provided with a front wall and loading supports pivoted onto the base, which are foldable substantially into an upright position when the cabin, loader and possibly the power source move to the front part of the base for receiving tree trunks and for hauling them to the loading area.

35. A forest machine as claimed in claim 34, wherein actuators are arranged to direct the front wall and the loading supports.

36. A forest machine as claimed in claim 18, wherein the front and rear frame forming the base are joined together using the slewing ring.
